(19) United States
(12) Patent Application Publication
(10) Pub. No.: US 2007/0187467 A1
(43) Pub. Date: Aug. 16, 2007

(54) Method for forming a stud bump

(75) Inventors: Toshihiko Toyama, Tokorozawa-shi (JP); Tatsunari Mii, Tachikawa-shi (JP)

Correspondence Address: KODA & ANDROLIA, 2029 CENTURY PARK EAST, SUITE 1140, LOS ANGELES, CA, 90067, US

(73) Assignee: Kabushiki Kaisha Shinkawa

(21) Appl. No.: 11/706,746

(22) Filed: Feb. 14, 2007

(30) Foreign Application Priority Data
Feb. 14, 2006 (JP) 2006-035981

(51) Int. Cl. A47J 36/02

(52) U.S. Cl. 228/101

(57) ABSTRACT

A method for forming stub bumps in, for instance, semiconductor device fabrication, including a bonded ball formation step for bonding a ball formed at a tip end of a wire passing through a capillary to a pad to form a bonded ball on the pad; a scratching step for, next, scratching a portion of the wire above the bonded ball with an interior edge of the capillary by moving the capillary; a bending step for, next, bending the scratched portion of the wire by moving the capillary; and a cutting step for, thereafter, cutting the wire from the scratched portion by closing a damper during an ascending motion of the capillary.

### BACKGROUND OF THE INVENTION

The present invention relates to a method for forming a stud bump in, for instance, semiconductor device fabrication.

A stud bump is a bonded ball, which is bonded to a die pad and has a wire (stud or standing wire) of a predetermined length (height). Such a stud bump is formed by a wire bonding apparatus or a bump bonding apparatus. The stud bumps formed on a die and conductors formed on a circuit board are bonded by a flip-chip bonding method.

In a semiconductor device that includes the above-described connections, in order to bond strongly a die and a circuit board, an adhesive is put between the two. In such cases, in a multiple-pin die in which a large number of stud bumps are provided, the gap between the pins are narrow, stud bump resistance is large, and it is difficult for the adhesives to reach all the way between the gaps. This circumstance has led, recently, to a demand for stud bumps having greater stud heights.

Japanese Patent Application Unexamined Publication Disclosure Nos. H10 (1998)-135220 and 2001-160566 (Japanese Patent No. 3566156), for example, disclose conventional methods for forming stud bumps.

In Japanese Patent Application Unexamined Publication Disclosure No. H10 (1998)-135220, a ball is formed at a tip end of a wire passing through a capillary, and this ball is bonded to a pad of an electronic circuit device or the like using the capillary to form a bonded ball. After that, the capillary is ascended for a predetermined amount (distance), so that the wire is cut by a method described below, at a position at the lower end of the capillary and sufficiently separated from the bonded ball, to form a stud bump.

More specifically, Japanese Patent Application Unexamined Publication Disclosure No. H10 (1998)-135220 discloses such wire cutting methods as described below.

In a first method, wire cutting is performed by causing an electric discharge against a part of a wire, which is at the capillary hole tip portion, by a discharge electrode attached to the side surface of a capillary.

In a second method, wire cutting is performed by irradiating a part of a wire, which is at the capillary hole tip portion, with a laser beam by a laser means deployed at the side of the lower end of a capillary.

In a third method, wire cutting is performed by blowing air onto a part of the wire, which is at the capillary hole tip portion, by an air nozzle deployed at the side of the end of a capillary.

In a fourth method, the capillary is comprised of a plurality of chuck segments, or the capillary is formed with a chuck only at the tip end, so that it is possible for the capillary to fasten and release a wire; a part of a wire, which is at the capillary hole tip portion, is scratched by the edge of the capillary, and the wire is cut by subjecting the wire to a pulling force.

In a fifth method, a cutter is deployed at the side of a capillary, the cutter is pushed against a part of a wire which is at the capillary hole tip portion, and the wire is cut by the cutter.

In a sixth method, breakpoints that are cuts or pressed-grooves are formed beforehand, at equal intervals in the longitudinal direction, on a wire that passes through a capillary, and the wire is cut by subjecting the wire to a pulling force.

On the other hand, Japanese Patent Application Unexamined Publication Disclosure No. 2001-160566 (Japanese Patent No. 3566156) discloses a wire bonding apparatus that includes a first wire clamper, which moves up and down (vertically) along with a capillary, and a second wire clamper, which is not vertically movable. This bonding apparatus works as follows:

A wire is brought to pass through the second wire clamper and the first wire clamper and then through the capillary, and, with the second wire clamper open and the first wire clamper closed, a ball is formed at the tip end of the wire passing through the capillary; then the first wire clamper is opened, and, due to the effect of the back tension acting on the wire, the ball comes up against the lower end of the capillary.

Next, the capillary and the first wire clamper are made to descend, then, after closing the second wire clamper, the capillary and the first wire clamper are made to ascend, and the wire is caused to extend from the lower end of the capillary.

Next, with the first wire clamper closed, and with the second wire clamper opened, the portion of the wire between the ball and the capillary is scratched by a scratching means provided in the wire bonding apparatus. Following that, the first wire clamper is opened, the capillary and the first wire clamper are caused to descend, and the ball is bonded to a pad, using the capillary, to form a bonded ball. Then, the capillary and the first wire clamper are caused to ascend, and, during this ascent motion, the first wire clamper is closed, the wire is pulled upward, and the wire is cut from the scratched portion to form a stud bump.

In both of the above-described conventional art, equipment or the like for cutting the wire is required and provided in the wire bonding apparatus. More specifically, in Japanese Patent Application Unexamined Publication Disclosure No. H10 (1998)-135220, a discharge electrode attached to the side surface of the capillary (first method), a laser means (second method), an air nozzle (third method), or a cutter (fifth method) or the like is required. It is also necessary either to install a special capillary (fourth method) or to form breakpoints at equal intervals in the longitudinal direction of the wire beforehand (sixth method). In Japanese Patent Application Unexamined Publication Disclosure No. 2001-160566 (Japanese Patent No. 3566156), a scratching means is required.

### BRIEF SUMMARY OF THE INVENTION

The object of the present invention is to provide a method for forming a stud bump wherein it is unnecessary to add any special equipment for executing wire cutting, and wherein stud bumps can be formed while freely controlling the height.

The above object is accomplished by unique steps of the present invention for a method for forming stub bumps, and the method comprises the steps of:
forming a bonded ball on a pad to bond a ball formed at an end of a wire passing through a capillary;
scratching a wire portion above the bonded ball with an interior edge portion of the capillary by moving the capillary;
bending a scratched portion of the wire by moving the capillary; and
cutting the wire from the scratched portion by closing a damper during an ascending motion of the capillary.

In this method of the present invention,
the scratching step includes ascending of the capillary from the bonded ball to an arbitrary height, moving of the capillary in a lateral direction, and descending of the capillary; and
the bending step includes moving of the capillary in a lateral direction toward the scratched portion side of the wire to pass the center of the bonded ball, and descending of the capillary.

As seen from the above, a scratch is made by a capillary in the portion of a wire located above the bonded ball, and this scratched portion is bent to make it easy to cut, and, after that, a stud bump is formed by the actions of the ascending motion of the capillary and of the closing motion of the clamper. Accordingly, there is no necessity to add any special wire cutting equipment to the wire bonding apparatus or bump bonding apparatus. Also, the height of the stud can be controlled by the height to which the capillary is made to ascend after bonded ball formation. Accordingly, stud height can be set freely or any desired height for a stud is obtainable.

### BRIEF DESCRIPTION OF THE SEVERAL VIEWS OF THE DRAWINGS

FIG. 1 shows steps (a) through (f) of forming a stud bump according to one embodiment of the present invention; and

FIG. 2 shows steps (a) through (c) that are continued from the step (f) of FIG. 1.

### DETAILED DESCRIPTION OF THE INVENTION

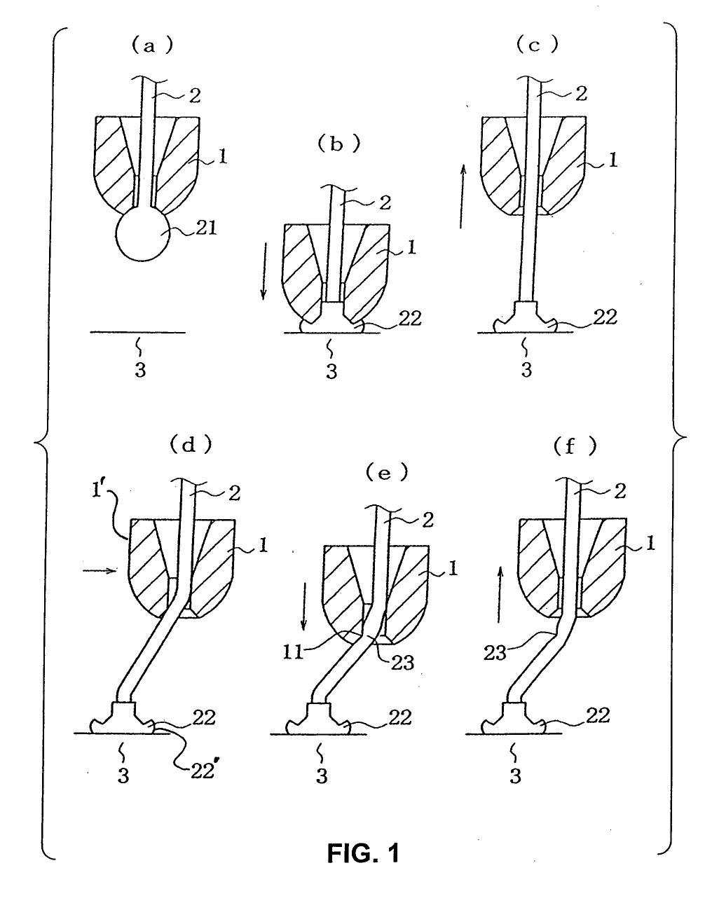

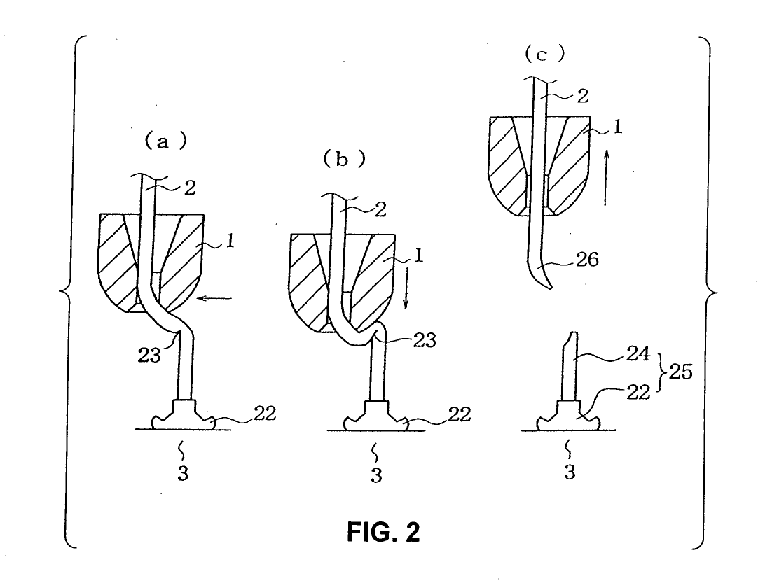

One embodiment of the method for forming a stud bump of the present invention will be described below with reference to FIG. 1 and FIG. 2, which is continued from FIG. 1.

In step (a) shown in FIG. 1, at the tip end of a wire 2 passing through a damper (not shown) and a capillary 1, a ball 21 is formed by an electric flame off probe (not shown), and then the clamper is opened.

Next, in step (b) of FIG. 1, the capillary 1 is caused to descend toward the pad 3, and the ball 21 is bonded to a pad 3 to form a bonded ball 22 on the pad 3.

In next step (c), the capillary 1 is caused to ascend for an arbitrary distance above the pad 3 to an arbitrary height.

Following that, in step (d), the capillary 1 is moved in a lateral direction or substantially parallel to the surface of the pad 3. More specifically, the capillary 1 is moved laterally (to the right-hand side in the shown embodiment of FIG. 1) for a distance that the outer surface (left-hand side surface 1′) of the capillary 1 is not moved over the edge (right-hand side edge 22′) of the bonded ball 22. The capillary 1, however, can be moved laterally such that the outer surface 1′ of the capillary 1 is moved over the right-hand side edge 22′ of the bonded ball 22 when such a longer moving distance is permissible due to, among others, the wire diameter, the degree of purity of the wire material and/or the viscosity characteristic of the adhesive that is filled in a space between a die and a circuit board.

Then, in the next step (e), the capillary 1 is caused to descend, making a scratch 23 in the wire 2 by an interior edge 11 of the capillary 1. In this step (e), the capillary 1 is descended for any distance between the position where the capillary 1 was at its lowest descended position in step (b) and the position where the capillary was at its arbitrarily ascended position in step (c).

Next, in step (f), the capillary 1 is caused to ascend.

In step (a) shown in FIG. 2, the step (a) of FIG. 2 being continued from step (f) of FIG. 1, the capillary 1 is moved in the lateral direction (to the left-hand side) toward the side of the wire 2 where the scratch 23 is made (in the opposite direction from the direction in step (d) of FIG. 1), so that it passes (is moved over) the center of the bonded ball 22.

Following this lateral motion of the capillary 1, the capillary 1 is caused to descend in the next step (b) of FIG. 2, so that bending occurs in a part of the wire where the wire is weakened because of the scratch 23, and so that the scratch 23 portion becomes easy to cut. In this step (b) of FIG. 2 as well, the capillary 1 is descended for any distance between the position where the capillary 1 was at its lowest descended position in step (b) of FIG. 1 and the position where the capillary was at its arbitrarily ascended position in step (c) of FIG. 1.

Next, in step (c) of FIG. 2, the capillary 1 is caused to ascend, and the clamper (not shown) closes during this ascending motion of the capillary 1. As a result, the wire is cut at the scratch 23 portion, and a stud bump 25 is obtained having a stud 24 formed on the bonded ball 22. A tail 26 is also formed at the tip end of the wire sticking out of the tip end of the capillary 1.

As seen from the above, in the present invention, a scratch 23 is made by the capillary 1 in the portion of the wire 2 above the bonded ball 22, the scratch 23 portion of the wire is bent to make this portion easy to cut, and then, by the actions of the ascending motion of the capillary 1 and the closing motion of the clamper, the wire is cut at the scratch 23 portion, and the stud bump 25 is thus formed on a pad. In other words, the stud bump 25 can be formed without adding any special equipment to the wire bonding apparatus but is formed by the movements of the capillary. In addition, the height of the stud 24 can be controlled by causing the capillary 1 to ascend for a certain (predetermined) distance after forming the bonded ball 22; accordingly, the stud 24 can be set freely at any desired height by varying the ascending distance of the capillary 1.

1. A method for forming stub bumps, said method comprising the steps of:
forming a bonded ball on a pad to bond a ball formed at an end of a wire passing through a capillary;
scratching a wire portion above said bonded ball with an interior edge portion of said capillary by moving said capillary;
bending a scratched portion of said wire by moving said capillary; and
cutting said wire from said scratched portion by closing a clamper during an ascending motion of said capillary.

2. The method for forming stub bumps according to claim 1, wherein said scratching step including
ascending of said capillary from said bonded ball to an arbitrary height;
moving of said capillary in a lateral direction; and
descending of said capillary.

3. The method for forming stub bumps according to claim 1, wherein said bending step including
moving of said capillary in a lateral direction toward said scratched portion side of said wire to pass a center of said bonded ball; and
descending of said capillary.
